(19) United States
(12) Patent Application Publication
(10) Pub. No.: US 2023/0417913 A1
(43) Pub. Date: Dec. 28, 2023

(54) IFF BEACON SYSTEM AND METHOD

(71) Applicant: CEJAY ENGINEERING, LLC, Bonita Springs, FL (US)

(72) Inventors: Derek HAYNES, Bonita Springs, FL (US); Guido Albert LEMKE, Hopewell Junction, NY (US); Mark HAYNES, Bradenton, FL (US)

(21) Appl. No.: 18/251,888

(22) PCT Filed: Nov. 11, 2021
(86) PCT No.: PCT/US2021/058949

§ 371 Date: May 5, 2023

Related U.S. Application Data
(60) Provisional application No. 63/113,068, filed on Nov. 12, 2020.

(51) Int. Cl. G01S 17/74

(52) U.S. Cl. CPC G01S 17/74; H04L 9/3226

(57) ABSTRACT

An interrogation device includes an emitter configured to emit an infrared (IR) inquiry signal to a target entity to determine if the target entity is a friendly entity. The interrogation device also includes a viewing device, configured to view IR signals, through which an IR response beacon signal from a target beacon of the target entity is viewed. The viewing device is configured to output a signal having a signal pattern of a response beacon signal expected from a beacon associated with the friendly entity, so that the target beacon is determined to be associated with the friendly entity if the response signal pattern of the target beacon matches the expected signal pattern in the viewing device.

### CROSS-REFERENCE TO RELATED APPLICATION

This application claims the benefit of priority to U.S. Provisional Application No. 63/113,068, filed on Nov. 12, 2020, the entire contents of which are incorporated herein by reference.

### FIELD OF THE DISCLOSURE

The present disclosure relates to an identification friend or foe (IFF) system and an IFF method.

### BACKGROUND

Identification friend or foe (IFF) systems include beacons capable of emitting near infrared (IR) signals used in conjunction with IF viewing equipment to identify operational active ground forces, from individuals to groups of soldiers. As time has progressed, enemies have acquired examples of equipment used by friendly force organizations and made copies of the beacons that are capable of emitting IR signals to be detected by the friendly force organizations. Improvements to IFF systems are therefore needed to improve security.

### SUMMARY

According to a first aspect of embodiments of the present disclosure, an interrogation device is provided. The interrogation device includes an emitter configured to emit an infrared (IR) inquiry signal to a target beacon to determine if the target beacon is associated with a friendly entity. The interrogation device also includes a viewing device, configured to view IR signals, through which an IR response beacon signal from the target beacon is viewed. The viewing device is configured to output a signal having a signal pattern of a response beacon signal expected from a beacon associated with the friendly entity, so that the target beacon is determined to be associated with the friendly entity if the response signal pattern of the target beacon matches the expected signal pattern in the viewing device.

According to a second aspect of embodiments of the present disclosure, a method for an interrogation device for determining whether a target beacon is associated with a friendly entity is provided. The method includes transmitting, by the interrogation device, an infrared (IR) inquiry signal to the target beacon. The method also includes, in response to receiving an IR response beacon signal from the target beacon, outputting, by a viewing device on the interrogation device configured to view IR signals, through which the IR response beacon signal from the target beacon is viewed, a signal having a signal pattern of a response beacon signal expected from a beacon associated with the friendly entity, so that the target beacon is determined to be associated with the friendly entity if the response signal pattern of the target beacon matches the expected signal pattern in the viewing device.

### BRIEF DESCRIPTION OF THE DRAWINGS

FIG. 1A schematically illustrates an interrogation device, consistent with an embodiment of the present disclosure.

FIG. 1B schematically illustrates an image viewed through a viewing device included in the interrogation device illustrated in FIG. 1A, according to an embodiment of the present disclosure.

FIG. 2 schematically illustrates a control panel included in the interrogation device illustrated in FIG. 1A, according to an embodiment of the present disclosure.

FIG. 3 schematically illustrates a beacon that is associated with a friendly entity, consistent with an embodiment of the present disclosure.

FIG. 4 schematically illustrates a receiver included in the beacon illustrated in FIG. 3, according to an embodiment of the present disclosure.

FIG. 5 illustrates a pre-deployment set-up process performed by one or more operators for an IFF system, according to an embodiment of the present disclosure.

FIG. 6 illustrates a deployment process performed by an initiator for an IFF system, according to an embodiment of the present disclosure.

FIG. 7 schematically illustrates an IFF process performed by an IFF system, according to an embodiment of the present disclosure.

FIG. 8 schematically illustrates another IFF process performed by an IFF system, according to another embodiment of the present disclosure.

FIG. 9 schematically illustrates another IFF process performed by an IFF system, according to still another embodiment of the present disclosure.

### DETAILED DESCRIPTION

Reference will now be made in detail to the present embodiments, examples of which are illustrated in the accompanying drawings. Wherever possible, the same reference numbers will be used throughout the drawings to refer to the same or like parts.

In an identification friend or foe (IFF) beacon system, an interrogation device transmits an inquiry signal to a target beacon. The inquiry signal is encoded with an identification code of the interrogation device. If the target beacon is associated with a friendly entity (e.g., a soldier in a friendly force organization), the target beacon will transmit an acknowledgement signal, which can be detected by the interrogation device. The acknowledgement beacon signal is encoded with the identification code of the interrogation device, which is extracted by the target beacon from the inquiry signal. Upon receiving the acknowledgement beacon signal, the interrogation device compares the identification code in the acknowledgement signal with its own identification code to make a decision of friend or foe. If the identification code in the acknowledgement signal matches the identification code of the interrogation device, the interrogation device determines that the target beacon is associated with a friendly entity. Otherwise, if the identification code found in the acknowledgement signal does not match the identification code of the interrogation device, the interrogation device determines that the target beacon is potentially associated with a hostile entity.

In the above-described IFF beacon system, the interrogation device needs to decode the acknowledgement signal in order to obtain the identification code carried by the acknowledgement signal, and then compare the obtained identification code with its own identification code in order to make a friend or foe decision. These processes performed by the interrogation device may undesirably prolong the entire IFF process, which may not be suitable in a battlefield environment.

Embodiments of the present disclosure provide an IFF system including one or more interrogation devices and one or more beacons. Each interrogation device includes a viewing device through which a response beacon signal transmitted from a target beacon is viewed. More particularly, an operator of the interrogation device directs, or aims, at a target entity for which friend/foe status is to be determined and triggers emission of an inquiry signal, e.g., an infrared (IR) inquiry signal, at the target entity. For example, the operator aims through the viewing device by positioning the interrogation device so that the target entity appears in a field of view of the viewing device, and then triggers the inquiry signal. A friendly entity associated with the IFF system is expected to have a beacon configured to emit a response signal, e.g., an IR response signal, identifiable as emitted from the friendly entity beacon, in response to the inquiry signal. The viewing device of the interrogation device is configured to display in the field of view a signal pattern of an expected response from the beacon associated with the friendly entity. Therefore, the operator of the interrogation device can determine if the beacon is associated with a friendly entity by observing the signal pattern of the response beacon signal displayed in the field of view with the expected signal pattern, and comparing them. If the displayed patterns match, then the target entity is a friendly entity.

The disclosed IFF system thereby eases the interrogation device operator's task of interpreting the interrogation response. The operator of the interrogation device maintains aim at the target entity to be able to send and receive communication from a specific beacon. This engages the operator's full visual attention, so to accomplish the task the operator triggers emission of the inquiry signal, and a response back is displayed in the same field of view due to the aiming of the interrogation device. In that field, the expected and returned light signals are shown, e.g., near each other, to make comparing them easy as well as intuitive. This comparison can be continued as long as the operator continues to trigger emission of the inquiry signal.

As used herein, the term “signal” refers to any kind of signal transmitted by an interrogation device or a beacon. The term “beacon signal” refers to a signal transmitted by a beacon. The beacon signal can be configured to flash on and off according to a pattern, which is referred to as a “signal pattern”. The term “signaling program” refers to a preestablished signal pattern. The term “initiator” refers to an operator of the interrogation device who initiates communication between the interrogation device and a beacon and remotely directs the beacon to respond to an inquiry signal from the interrogation device.

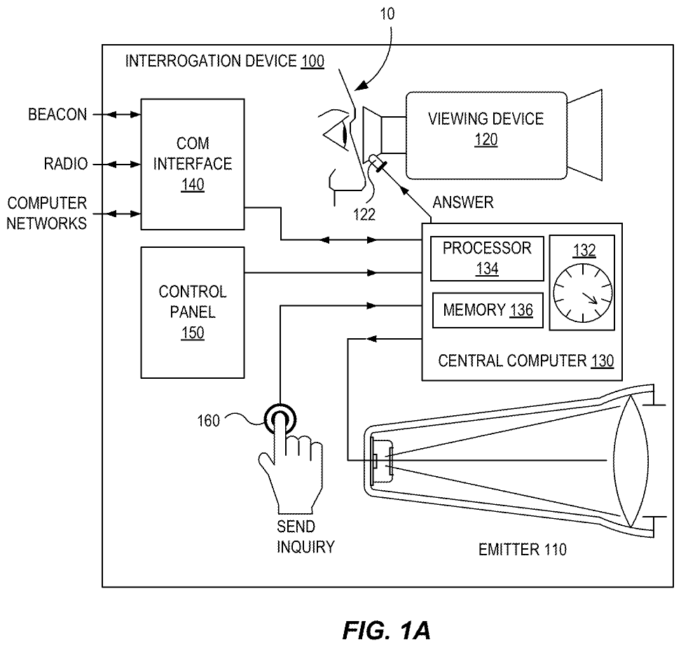

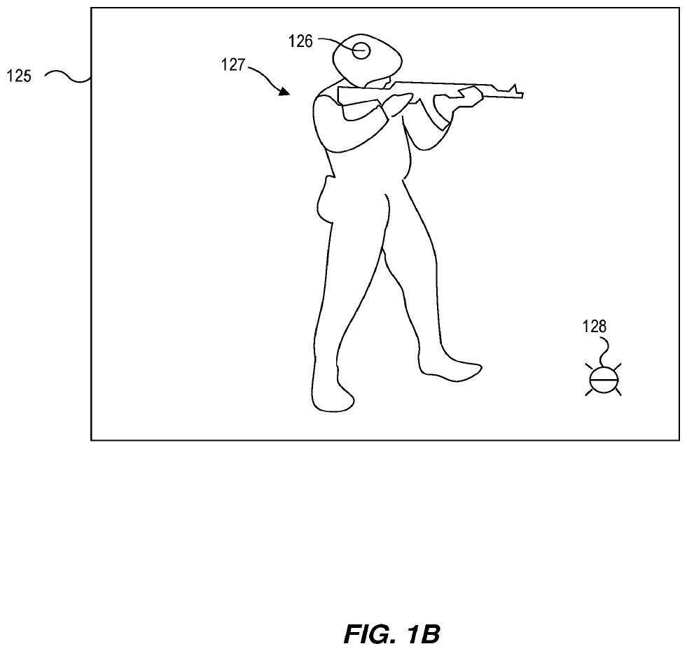

FIG. 1A schematically illustrates an interrogation device 100, consistent with an embodiment of the present disclosure. As illustrated in FIG. 1A, interrogation device 100 includes an emitter 110, a viewing device 120, a central computer 130, a communication interface 140, a control panel 150, and a push button 160.

Emitter 110 is configured to, in response to an input from an initiator 10 during operation of interrogation device 100 (also referred to as “deployment”), emit an inquiry signal to a target entity to be interrogated for an IFF response, to determine if the target entity is associated with a friendly entity. Emitter 110 may be an optical communication emitter, which can emit signals having long-range, narrow-beam infrared (IR) characteristics. Thus, the inquiry signal may be an IR inquiry signal. The inquiry signal may have a wavelength selected from a range from 880 nm to 2900 nm. In addition, the inquiry signal may be a frequency modulated optical signal carrying an inquiry message, which may be an encrypted digital message. During the deployment of interrogation device 100, emitter 110 is aimed at the target entity.

Viewing device 120 is configured to view IR signals. An IR response signal from a beacon of the target entity may be viewed through viewing device 120 by initiator 10. Viewing device 120 includes an output device 122 configured to output a signal having a signal pattern of a response signal expected from a target beacon associated with the friendly entity, so that initiator 10 can determine the target beacon is associated with the friendly entity if the response signal pattern of the target beacon matches the expected signal pattern output from output device 122. Output device 122 may be a light source (e.g., a light emitting diode (LED)) attached to a ring of an eyepiece of viewing device 120 and driven by central computer 130 to generate visible light according to the expected signal pattern. The visible light may be displayed in a field of view of viewing device 120 by attaching the light source to an eyepiece ring on a viewfinder of viewing device 120. Alternatively, as further described below with reference to FIG. 1B, the output signal of output device 122 may instead be coupled to drive an indicator light within a field of view display of viewing device 120. Still alternatively, output device 122 may be a speaker that generates an audible signal according to the expected signal pattern. Still alternatively, output device 122 may use haptic technology to, for example, generate haptics signals (e.g., vibrations), discernable by initiator 10, according to the expected signal pattern.

In the embodiment illustrated in FIG. 1A, viewing device 120 may be a night vision glass (NVG), which displays a night vision image of an aiming point of emitter 110. In the present disclosure, viewing device 120 is also referred to as “NVG 120”. NVG 120 may be a commercially available night vision telescope, which has been modified by the addition of output device 122, provided as a light source (hereinafter referred to as “light source 122”) that functions as a small indicator light for displaying the expected response signal pattern to initiator 10. Additionally or alternatively, the expected response signal pattern may be optically superimposed as an indicator light in the middle or side of the night vision image displayed by NVG 120 to narrow a relevant part of the field of view thereby making interpretation more convenient and more possible.

FIG. 1B schematically illustrates a night view image 125 viewed through viewing device 120, according to an embodiment of the present disclosure. As illustrated in FIG. 1B, night view image 125 shows a beacon signal 126 emitted from a beacon mounted on a helmet of a soldier 127. Beacon signal 126 flashes on and off according to a signal pattern. On the lower edge of night view image 125, an indicator light 128 flashes on and off according to an expected response signal pattern expected from a solider associated with a friendly group.

Referring back to FIG. 1A, emitter 110 and NVG 120 are aligned so that the image displayed by NVG 120 is positionally aligned to appear in the same location as the pointing, i.e., aiming, direction of emitter 110. In the embodiment illustrated in FIG. 1A, NVG 120 is integrated with emitter 110. In other embodiments, emitter 110 and NVG 120 can be separate units. If emitter 110 and NVG 120 are separated from each other, the alignment between emitter 110 and NVG 120 is performed by an operator (e.g., the initiator, or an operator other than the initiator) during a set-up process before deployment. If emitter 110 and NVG 120 are integrated, the alignment is performed at the time of manufacture or maintenance. Output device 122 is controlled by central computer 130 to flash, emit sound, or vibrate with the same signal pattern at the same timing as the expected response (also referred to as an “answer”) from a “friendly” beacon, which is a beacon associated with a friendly entity.

Central computer 130 stores one or more signaling programs and settings used during deployment of interrogation device 100, responds to initiator 10's input from control panel 150, creates and sends inquiry signals to a target entity consistent with one of the signaling programs selected by initiator 10, and displays expected beacon responses to initiator 10. Central computer 130 includes a high stability clock 132, a processor 134, and a memory 136. Clock 132 provides a time standard of interrogation device 100. Processor 134 may include one or more processing devices, such as a central processing unit (CPU), which executes program instructions to perform various functions consistent with the embodiments of the present disclosure. Memory 136 may be one or more storage devices that maintain data (e.g., instructions, software applications, information used by and/or generated during execution of instructions or software applications, etc.) used by processor 134. For example, memory 136 may store one or more factory-installed or operator-entered signaling programs or passwords (e.g., code of the day). Memory 136 may also store one or more computer programs that, when executed by processor 134, perform one or more processes consistent with the present disclosure. Memory 136 may further store information used by and/or generated during execution by processor 134, of programs that perform one or more processes consistent with the present disclosure. Memory 136 may include any kind of storage devices that maintain data. For example, memory 136 may include one or more of read-only memory (ROM), random-access memory (RAM), flash memory, or the like.

Communication interface 140 includes communications hardware for one or more of wired, wireless, and/or optical communication with external beacon devices, radios, and computer networks used during a set-up process of interrogation device 100, also referred to as a “pre-deployment process”, described more fully below.

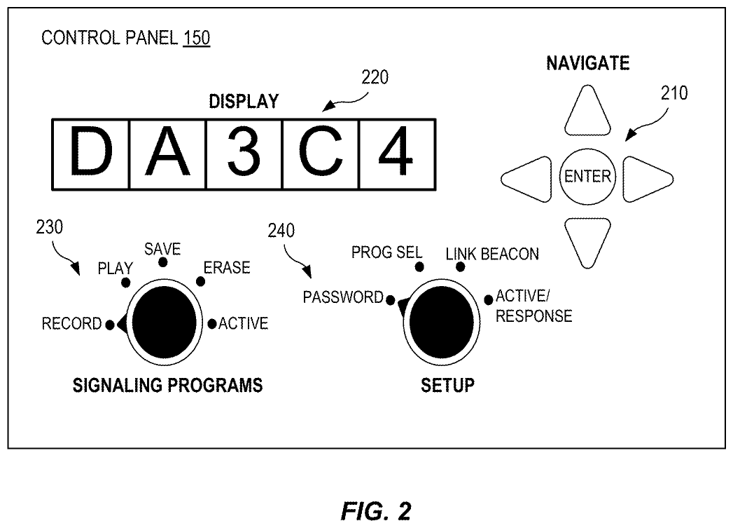

Control panel 150 is configured to receive initiator 10's input, and transmits initiator 10's input to central computer 130. FIG. 2 schematically illustrates details of control panel 150, according to an embodiment of the present disclosure.

As illustrated in FIG. 2, control panel 150 includes a keypad 210, a display 220, a first switch 230, and a second switch 240. Keypad 210 is a five-button navigation pad for data input and command entry. The five buttons include “Up,” “Down,” “Right,” “Left,” and “Enter.” For example, the “Right” and “Left” buttons may be used to select an individual character displayed in display 220; the “Up” and “Down” buttons may be used to change the selected character; and the “Enter” button may be used to enter the changes made to the selected character. For another example, in a program select mode, the “Up” and “Down” buttons may be used to select a signaling program, and thus an entire character string displayed in display 240, which represents an identification of a signaling program, may be changed. Display 220 is a character display for displaying data or commands inputted by initiator 10. First switch 230 is a multi-position selector switch for setting up signaling programs. First switch 230 may switch between at least, “Record,” “Play,” “Name,” “Erase,” and “Active.” “Record” is selected for entry and recording of a signaling program. “Play” is selected to play to show to the user a stored signaling program. “Name” is selected to record and associate a name to a signaling program. “Erase” is selected to erase a recorded signaling program. “Active” is selected to choose which signaling program is to be used during a particular deployment to prevent inadvertent “Record” “Play” “Save” or “Erase.” Second switch 240 is a multi-position selector switch for setting up operational information input. Second switch 240 may switch between, at least, “Password,” “Prog Sel,” “Link Beacon,” and “Active/Response”). “Password” is selected to input a password to gain control of interrogator device 100. “Prog Sel” is selected to select a signaling program for a deployment. “Link Beacon” is selected to link interrogation device 100 with an external beacon device by communicating the signlaing program to be used for verification and synchronizing clock settings. “Active/Response” is selected to instruct interrogation device 100 to be active or to respond to an inquiry in field deployment.

The configuration of control panel 150 is not limited to the configuration illustrated in FIG. 2. Control panel 150 may be configured with any user interface devices that enable initiator 10 to control the operations described therein.

Referring back to FIG. 1A, interrogation device 100 includes push-button 160, which can be pressed by initiator 10 while looking thru NVG 120 to trigger emitter 110 to send the inquiry signal to the target entity to be interrogated. Observing a target beacon flashing a response beacon signal having the same pattern as the one output by output device 122 in unison (e.g., flashing, playing sounds, or vibrating according to the same pattern at the same timing) confirms to initiator 10 that the target beacon is a “friendly” beacon.

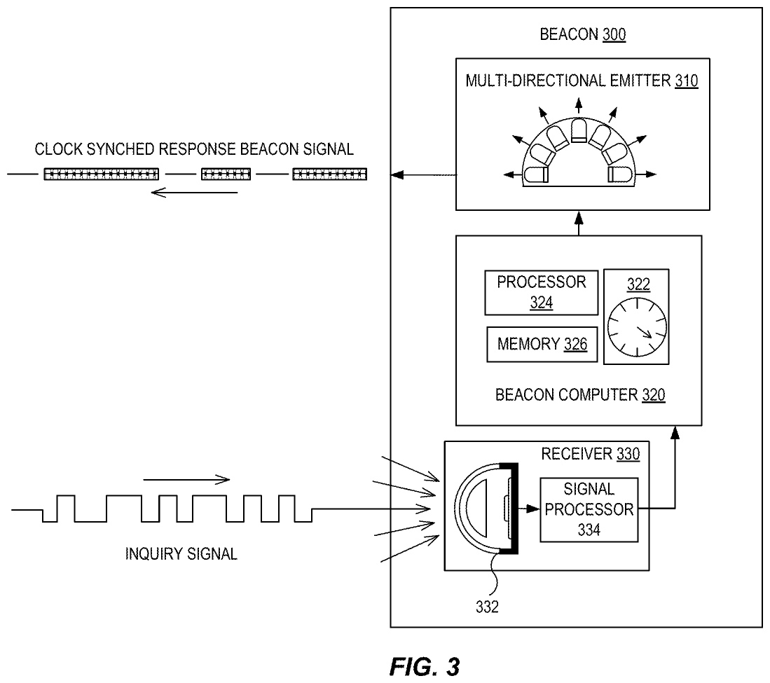

FIG. 3 schematically illustrates a beacon 300 that is associated with a friendly entity, consistent with an embodiment of the present disclosure. As illustrated in FIG. 3, beacon 300 includes an emitter 310, a beacon computer 320, and a receiver 330.

Emitter 310 is controlled by beacon computer 320 to emit a beacon signal with a particular flashing signal pattern in response to an inquiry signal received from interrogation device 100. Emitter 310 may be a multi-directional emitter 310 that is capable of emitting the beacon signal in multiple directions. Like the inquiry signal emitted by interrogation device 100, the beacon signals are IR signals that have long-range, narrow-wavelength beam infrared (IR) characteristics. Narrow-wavelength refers to the IR frequency spread of the signal, e.g., 900 nm±10 nm. On the other hand, the angle of emission coverage of the beacon signal is as wide as possible, typically one-half a hemisphere, as the orientation between beacon 300 and interrogation device 100 is not known and so a wide angle maximizes the probability of successful communication. The IR beacon signals may have a wavelength selected from a range from 880 nm to 2900 nm.

Beacon computer 320 includes both hardware and software that functionally tie other components of beacon 300 together and drive the other components. Beacon computer 320 includes a beacon clock 322, a processor 324, and a memory 326. Beacon clock 322 is an internal high stability clock, which has been synchronized with clock 132 of interrogation device 100 prior to deployment (also referred to herein as “pre-deployment”), as described more fully below. Processor 324 may be one or more processing devices, such as a central processing unit (CPU), which executes program instructions to perform various functions, such as the processes described in this disclosure. Memory 326 may be one or more storage devices that maintain data (e.g., instructions, software applications, information used by and/or generated during execution of instructions or software applications, etc.) used by processor 324. For example, memory 326 may store one or more factory-installed or operator-entered signaling programs or passwords (e.g., code of the day), or signaling programs or passwords received from interrogation device 100. Memory 326 may also store one or more computer programs that, when executed by processor 324, perform one or more processes consistent with the present disclosure. Memory 326 may further store information used by and/or generated during execution, by processor 324, of programs that perform the one or more processes consistent with the present disclosure. Memory 326 may comprise any kind of storage devices that maintain data. For example, memory 326 may include one or more of ROM, RAM, flash memory, or the like.

Receiver 330 includes an optical detector 332 configured to detect the inquiry signal sent by interrogation device 100 and a signal processor 334 configured to process the inquiry signal. The inquiry signal may be digital. Optical detector 332 may have a limited angle of reception, and the direction of the signals from interrogation device 100 is not likely to be known beforehand. Therefore, in some embodiments, receiver 330 may include an array of optical detectors 332 to increase the field of detection coverage. The array of optical detectors 332 may be integrated into wearable electronics worn by a user or in a hemispherical dome-like device. The more individual optical detectors 332 there are, the more responsive beacon 300 is. Hence, it may be preferable to configure an array with as many optical detectors 332 as practical.

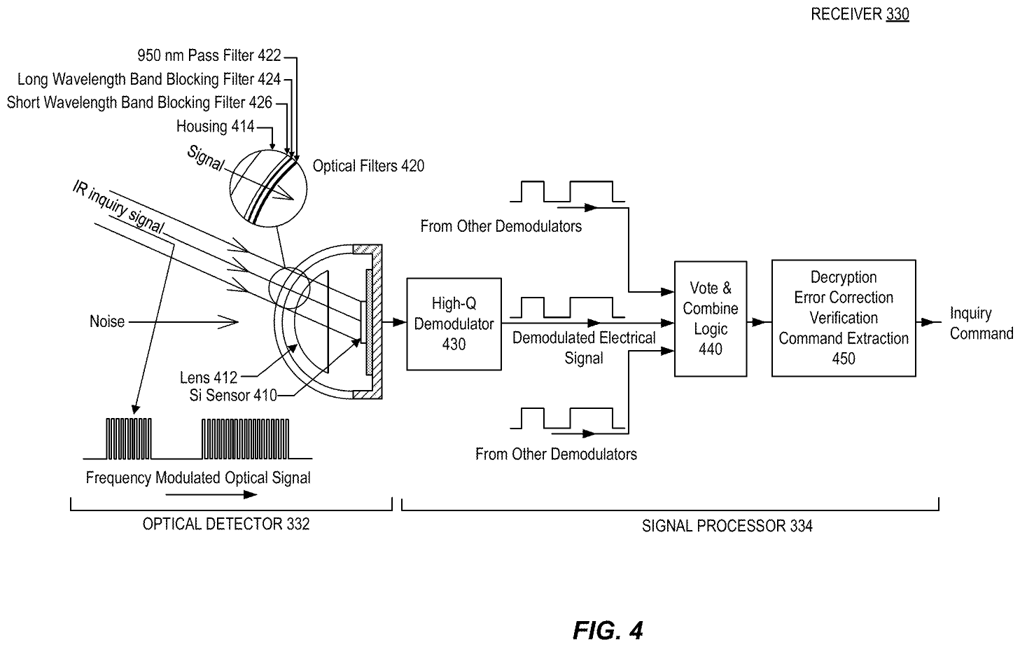

FIG. 4 schematically illustrates receiver 330, according to an embodiment of the present disclosure. As described above, receiver 330 includes optical detector 332 and signal processor 334. As illustrated in FIG. 4, optical detector 332 includes a photosensor 410 (e.g., a silicon (Si) sensor) or other photosensor, and a lens 412 disposed inside a transparent housing 414, and a plurality of optical filters 420 formed on housing 414. The plurality of optical filters 420 include at least a narrow-band interference pass filter 422 (e.g., a 950 nm pass filter), a long wavelength band blocking filter 424, and a short wavelength band blocking filter 426. Signal processor 334 may include a high-Q narrow frequency band demodulator 430 to reject unwanted noise in the signal, a vote and combine logic module 440, and a decryption, error correction, verification, and command extraction module 450. In the embodiment illustrated in FIG. 4, only one optical detector 332 and one high-Q demodulator 430 are shown in the illustration of receiver 330. In some other embodiments, multiple optical detectors 332 and multiple high-Q demodulators 430 may be included. Each one of the multiple optical detectors 332 may be connected with a corresponding one of the multiple high-Q demodulators 430. In the embodiments illustrated in FIGS. 3 and 4, signal processor 334 is included in receiver 330. In some other embodiments, one or more components of signal processor 334 may be included in beacon computer 320 and may be implemented as different programming protocols executed by processor 324. For example, vote and combine logic module 440 may be implemented as a vote logic and a combine logic respectively executed by processor 324.

Referring back to FIG. 4, the IR inquiry signal transmitted from interrogation device 100 is a frequency modulated optical signal modulated at a fixed frequency by interrogation device 100 before transmission, in order to be distinguished from background noise. The IR inquiry signal is filtered optically by narrow-band interference pass filter 422 and short and long wavelength band pass filters 426 and 424 before being detected by optical detector 332, in order to improve the signal-to-noise ratio of the received signal. After being detected by optical detector 332, the IR inquiry signal is demodulated by high-Q demodulator 430 to obtain a demodulated electrical signal. The demodulated electrical signal is transferred to vote and combine logic module 440. In embodiments in which multiple optical detectors 332 and multiple high-Q demodulators 430 are included, the multiple optical detectors 330 may be within the field of view of interrogation device 100 and thus may simultaneously detect the same inquiry signal transmitted from interrogation device 100. As a result, each one of the multiple high-Q demodulators 430 may demodulate the signal received by the corresponding optical detector 332 and transfer the demodulated electrical signal to vote and combine logic module 440. Thus, vote and combine logic module 440 may receive multiple demodulated electrical signals.

Vote and combine logic module 440 includes a vote logic and a combine logic respectively executed by a processor (e.g., processor 324 or another processor included in signal processor 334). The vote logic is configured to monitor all input signals concurrently in real time and combines the input signals in those cases where the same inquiry signal has been detected by the multiple optical detectors 332. For example, when two out of three signals received from three optical detectors 332 agree (i.e., are the same), the vote logic combines the two signals. The combine logic is configured to detect signal continuity among the signals detected by optical detectors 332 and, when possible, assemble pieces of the signals detected by different optical detectors 332 into a full message. For example, due to movement, a first piece of the inquiry signal may be detected by a first optical detector 332 while a second piece of the inquiry signal is detected by a second optical detector 332, and the first piece and the second piece may overlap with each other. The combine logic combines the first and second pieces together into a full message.

Once vote and combine logic module 440 obtains the full message, vote and combine logic module 440 transfers the full message to decryption, error correction, verification, and command extraction module 450. Decryption, error correction, verification, and command extraction module 450 is configured to decrypt, error correct, and verify the message for content applicability. If all steps are passed successfully, decryption, error correction, verification, and command extraction module 450 is further configured to extract a command carried in the message, and pass the extracted command to beacon computer 320 for execution.

Referring back to FIG. 3, in response to a command that directs beacon 300 to respond with a beacon signal with a particular flashing signal pattern, beacon computer 320 controls emitter 310 to emit a response beacon signal. Beacon computer 320 controls the timing of the flashing of the response beacon signal according to the clock times provided by beacon clock 322 that has been previously synchronized to clock 132 in interrogation device 100. The timing and the pattern of the flashing of the response beacon signal expected from beacon 300 will be duplicated by central computer 130 of interrogation device 100 which controls output device 122 (e.g., a light source) included with viewing device 120 to function as an indicator light that outputs indicator light flashes according to the expected timing and expected pattern of the response beacon signal expected from beacon 300. Observing that both the indicator light and the response beacon signal from beacon 300 flash in unison (i.e., in the same pattern with the same timing), initiator 10 confirms that beacon 300 is a “friendly” beacon.

In some embodiments, beacon 300 may be the beacon disclosed in U.S. Pat. No. 9,866,369 B1, which is incorporated herein by reference, modified to include an array of optical detectors 332 and signal processor 334. Interrogation device 100 may have the clock and code functionality of beacon 300, and interrogation device 100 and beacon 300 are synchronized with each other prior to deployment.

According to an embodiment of the present disclosure, an IFF system includes one or more interrogation devices 100 operable by initiator 10, and one or more beacons 300 carried by friendly entities. Interrogation devices 100 and beacons 300 are data and time synchronized by a set-up process prior to field deployment. Hereinafter, the set-up process prior to field deployment is referred to as a “pre-deployment set-up process.”

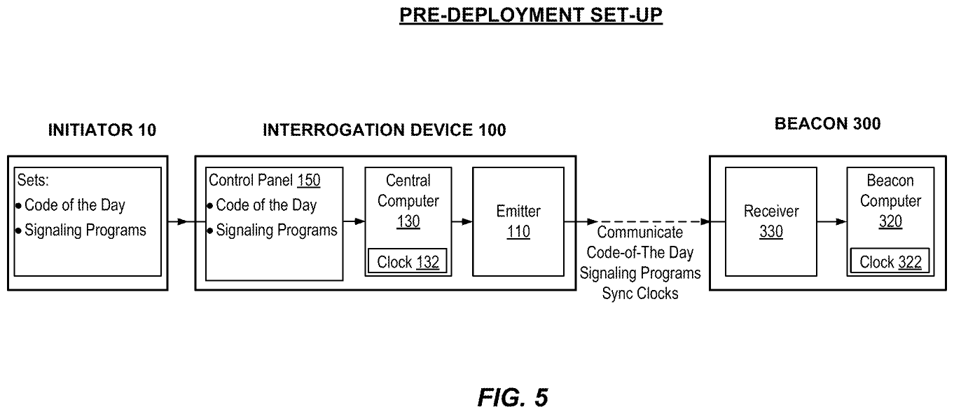

FIG. 5 illustrates a pre-deployment set-up process performed by one or more operators of the IFF system including interrogation device 100 and beacon 300, according to an embodiment of the present disclosure.

As illustrated in FIG. 5, during the pre-deployment set-up process, an operator, e.g., initiator 10, provides a security code (i.e., “code of the day”) and sets the signaling programs that are to be used during deployment. This information may be entered by initiator 10 into interrogation device 100 via control panel 150 (as illustrated in FIG. 5), or may be communicated electronically to interrogation device 100 from an external device such as a computer via communication interface 140. As used herein, a security code is a password that all participants of a group share so they will know to respond only to each other. Signaling programs are pre-established signal patterns. In order to describe the pre-deployment set-up process, an exemplary deployment process is briefly described below:

Initiator 10: Sends, through interrogation device 100, a password “Oct1” and a command “reply with signaling program No. 6”.

Beacon 300: Receives signal from interrogation device, validates encrypted signal, checks password “Oct1”, retrieves signaling program No. 6 from memory 326, and transmits signaling program No. 6 via emitter 310 which is timed by the clock setting in beacon 300 which will be in synchronism with the clock setting of interrogation device 100 as both had been synchronized during the pre-deployment set-up process.

Initiator 10: Looks for a response through NVG 120 while output device 122 (e.g., a light source) is outputting signals, e.g., flashing, according to signaling program No. 6 at the same time as the expected response.

The pre-deployment set-up process is performed to ensure that the one or more beacons 300 to be used for the deployment have the same data as the data that has been entered into interrogation device 100 (i.e., the code of the day and the signaling programs). During the pre-deployment set-up process, the data may be entered into the one or more beacons 300 by interrogation device 100 (or another external device) transmitting an optical-link signal carrying the data to be entered. For example, the optical-link signal may be an IR-link signal having a predetermined frequency of, e.g., 37 kHz, and each one of the one or more beacons 300 may include an IR-link detector and an IR-link emitter used for communicating data carried by IR-link signals with external devices. Alternatively, the data may be entered into the one or more beacons 300 by using wired, wireless, or radio communication means.

Part of the pre-deployment set-up process also synchronizes one or more clocks 322 of the one or more beacons 300 with clock 132 of interrogation device 100. Once synchronized, clocks 322 and 132 provide time consistency for the duration of the deployment that is sufficiently accurate, so that the same signal patterns emitted by different beacons 300 will appear to initiator 10 to be flashing in unison (i.e., at the same timing).

In some embodiments, once a beacon 300 has been synchronized with interrogation device 100, the synchronized beacon 300 can then be used subsequently to synchronize additional beacons 300, since the synchronized beacon 300 has all the information and time settings received from interrogation device 100. The subsequent synchronization of additional beacons is achieved by using a handshake feature of all of the beacons 300. According to the handshake feature, once one beacon is programed, the programed beacon can be shown to another beacon (e.g., a brother beacon of the programed beacon), and the brother beacon handshakes with the programmed beacon, installs the same signal on the same clock timing, and confirms that the handshake process has been completed.

The synchronization between interrogation device 100 and the one or more beacons 300, and among beacons 300, improves communications reliability. Once synchronized, communication messages are sent by interrogation device 100 or by a beacon 300 at pre-set clock times that are known to a receiving beacon 300, thereby reducing uncertainty and noise factor.

In addition, the synchronized clocks between interrogation device 100 and the one or more beacons 300, simplify beacon signaling program recognition by initiator 10 to a straightforward comparison between what is seen through NVG 120 and a flashing light signal, an audible signal, or a haptic (vibration) signal output from output device 122 representing the expected response from beacon 300 being interrogated. This is achieved as follows. The beacon signal emitted by beacon 300 begins at pre-set clock times known to central computer 130 of interrogation device 100, as is the pattern of the beacon signal that is expected from beacon 300. With that information, central computer 130 re-creates the expected response beacon signal with compensated timing including compensations for signal transmission and processing time delays. This re-created beacon signal is displayed in the NVG viewfinder as a flashing light pattern (or generated as an audible or haptic signal) at a timing that will match a timing of the signal pattern of the response beacon signal received from beacon 300 that had been interrogated.

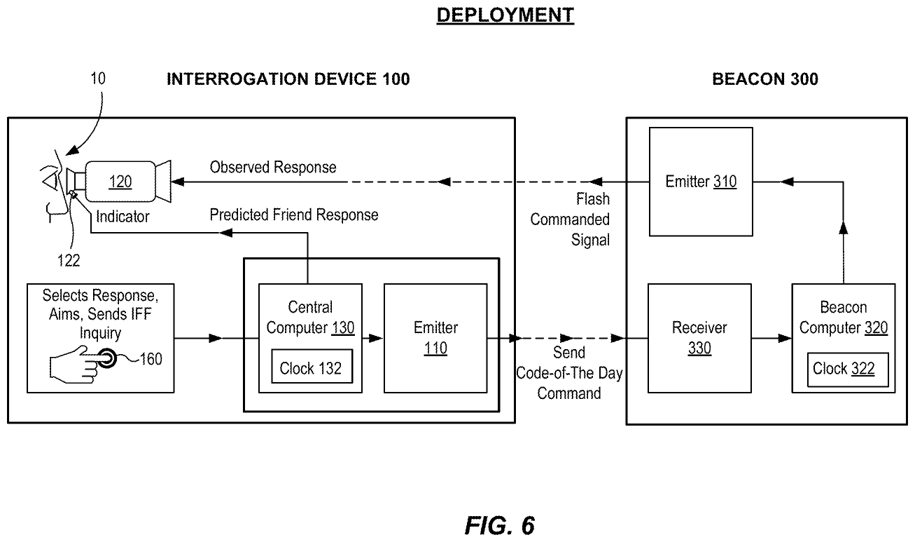

FIG. 6 illustrates a deployment process performed by initiator 10 for the IFF system after the pre-deployment set-up process, according to an embodiment of the present disclosure. During the deployment process, initiator 10 uses interrogation device 100 to determine if a potential target, i.e., target entity, is friend or foe.

As illustrated in FIG. 6, looking thru NVG 120, initiator 10 aims emitter 110 at the target entity to be identified as friend or foe and presses button 160, which triggers emitter 110 (e.g., a long-range, narrow-beam IR communications emitter) to transmit an inquiry signal. The inquiry signal may include an encrypted digital message. A payload contained in this message includes the code of the day set up during the pre-deployment set-up process together with a command to a receiving beacon as to the expected response action to be taken. For example, the expected response action may be emitting a beacon signal having a particular signal pattern. NVG 120 and emitter 110 can be integrated or separated from each other. NVG 120 and emitter 110 are aligned so that emitter 110 directs the inquiry signal to where NVG 120 is aimed.

When the target entity carries beacon 300 that has been previously linked to interrogation device 100, receiver 330 of beacon 300 receives the inquiry signal transmitted from interrogation device 100, and signal processor 334 validates data integrity of the message included in the inquiry signal (e.g., by checking that the message is in an expected encrypted format and is mathematically correct). Beacon computer 320 determines if the message applies to that beacon 300, then if so, executes the command contained in the message.

Commands contained in a message payload that call for a beacon response of flashing IR beacon signals include:
“Ping”: Respond back immediately with a single flash.
“Sync Ping”: Respond with a single flash that is time-synchronized to the clock.
“Play Once”: Emit current signaling program once without clock synchronization. In such cases without clock synchronization, the emitted beacon signal may not match the expected response beacon signal created by interrogation device.
“Play On”: Emit current signaling program continuously without clock synchronization.
“Play Sync1”: Emit current signaling program once with clock synchronization.
“Play Synced”: Emit current program continuously with clock synchronization.
“Change To”: Change to different signaling program as indicated.

Initiator 10, continuing to look through NVG 120, will see, on the side or middle of the viewfinder within NVG 120, a small indicator light that will be flashing the response signal expected from beacon 300, only if synchronization is specified by the command contained in the inquiry signal. A response beacon signal from a “friendly” entity will be seen through NVG 120 as a flashing signal matching the flashing indicator light that simulates the expected response in real time.

Should more certain verification be called for (e.g., no response is received, or the response beacon signal does not match the expected signal), initiator 10 can use control panel 150, associated with interrogation device 100, to request beacon 300 to flash a different signaling program or a different response.

In addition to commands to beacons that call for a flashing response, initiator 10 can also use interrogation device 100 to control other beacon aspects such as:
“Resume”: Resume prior operating state.
“Stand-By”: Put the beacon into a stand-by mode.
“Friendly”: Inform beacon user that they have been confirmed as “Friendly.”
“Silent”: Don't inform beacon user that they have been interrogated.
“Interrogated”: Inform beacon user valid interrogation inquiry received from a non-linked Transmitter. This is an alert only to the beacon user that lets the user know that there are other groups active in the vicinity. But, as it is not linked to this transmitter, the interrogated beacon will not respond to the transmitter with a signal that would identify it as a friendly.
“Re-Link”: Modify linkage to the interrogation device.
“Re-Sync”: Re-synchronize clock.

Additional commands can be added as needs arise.

During the deployment process, there are two possible ways a friendly beacon 300 can respond to an inquiry signal transmitted from interrogation device 100. In the first way, beacon 300 may respond with its preset individual signaling program. In the second way, beacon 300 may respond with the same signaling program received from interrogation device 100, i.e., a reflection of interrogation device 100's signaling program. The manner of beacon 300 responding to the inquiry signal can be selected by a mission commander before deployment, i.e., during the pre-deployment set-up process, as well as after deployment as the information transfer process is the same in both cases.

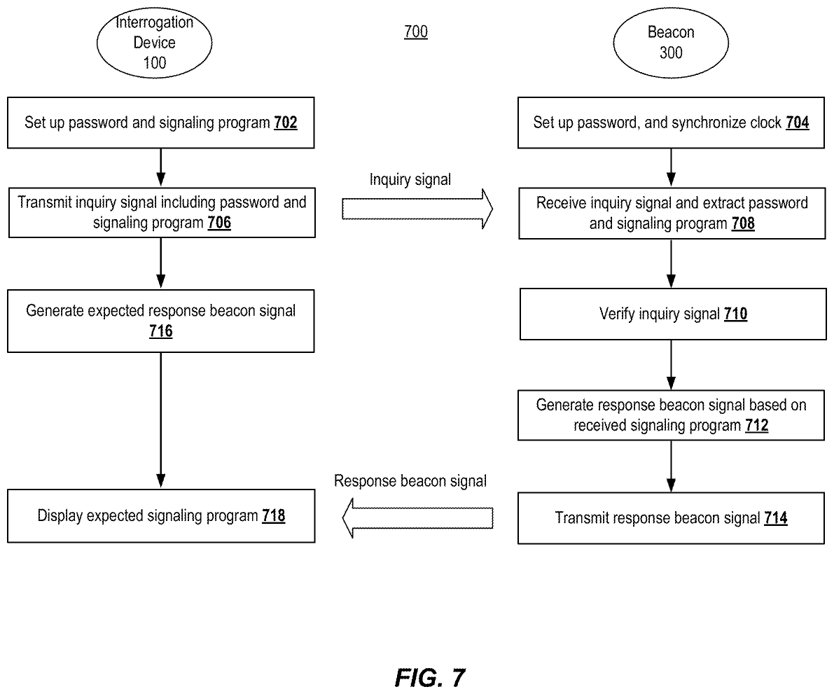

FIG. 7 schematically illustrates an IFF process 700 performed by an IFF system including interrogation device 100 and beacon 300, according to an embodiment of the present disclosure. In the embodiment illustrated in FIG. 7, beacon 300 is configured to, upon detection of an inquiry signal from interrogation device 100, transmit a response beacon signal according to a signaling program included in the inquiry signal.

As illustrated in FIG. 7, in step 702, interrogation device 100 sets up a password and a signaling program. The signaling program contains a signal pattern according to which a beacon signal flashes on and off. Interrogation device 100 may receive the password and the signaling program from a user input via control panel 150 of interrogation device 100, and may store the password and the signaling program in memory 136. Alternatively, interrogation device 100 may receive the password and the signaling program from an external device through communication interface 140.

In step 704, beacon 300 sets up the same password as interrogation device 100, and is synchronized with interrogation device 100. For example, in the embodiment illustrated in FIG. 7, beacon 300 may receive a signal containing the password and clock synchronization data (e.g., current clock time), from interrogation device 100. Beacon 300 may save the password in memory 326, and adjust clock 322 according to the clock synchronization data. Alternatively, beacon 300 may receive the password and the clock synchronization data from another beacon device or another interrogation device that has been previously set-up with interrogation device 100. Steps 702 and 704 are performed during the pre-deployment set-up process described with reference to FIG. 5.

In step 706, interrogation device 100 transmits an inquiry signal to a target entity, here assumed to include beacon 300. The inquiry signal includes the password and the signaling program that were set up in step 702. For example, initiator 10 of interrogation device 100 may see, through NVG 120, a target entity (e.g., a soldier in the field), and initiator 10 pushes button 160 on interrogation device 100. In response to button 160 being pushed, interrogation device 100 transmits the inquiry signal.

In step 708, beacon 300 receives the inquiry signal and extracts the password and the signaling program included in the inquiry signal. For example, optical detector 332 of beacon 300 may detect the inquiry signal, and signal processor 334 may process the received inquiry signal and extract the password and the signaling program.

In step 710, beacon 300 verifies the received inquiry signal. For example, processor 324 of beacon 300 compares the extracted password with the password stored in memory 326. If the extracted password is the same as the stored password, beacon 300 determines that the inquiry signal is received from a “friendly” interrogation device. In step 712, processor 324 of beacon 300 generates a response beacon signal based on the signaling program extracted from the inquiry signal. In step 714, beacon 300 transmits the response beacon signal according to a timing provided by clock 322 of beacon 300.

While beacon 300 generates and transmits the response beacon signal, in step 716, interrogation device 100 generates an expected response beacon signal based on the signaling program which is set up in step 702 and included in the inquiry signal. Interrogation device 100 generates the expect response beacon signal according to a timing provided by clock 132, including compensations for signal transmission between interrogation device 100 and beacon 300 and processing time delays by interrogation device 100 and beacon 300.

In step 718, output device 122 of interrogation device 100 outputs (e.g., displays by an indicator light) the expected response beacon signal in a view finder of NVG 120 through which the response beacon signal transmitted from beacon 300 is observed. By observing the expected response beacon signal and the response beacon signal transmitted from beacon 300 at the same time in the same viewfinder, initiator 10 can make a friend or foe decision for beacon 300. For example, if the signal pattern of the response beacon signal matches the signal pattern of the expected response beacon signal, initiator 10 determines that beacon 300 is associated with a friendly entity. Otherwise, if the signal pattern of the response beacon signal does not match the signal pattern of the expected response beacon signal, initiator 10 may determine that beacon 300 is not associated with a friendly entity, or that further inquiry is needed. In such case, initiator 10 may trigger interrogation device 100 to transmit a second inquiry signal to check whether beacon 300 is associated with a hostile entity. Initiator 10 may also trigger interrogation device 100 to transmit the second inquiry signal when no response is received from beacon 300. The second inquiry signal may be the same as, or different from, the previously transmitted inquiry signal.

In some embodiments, beacon 300 is included in a group of beacons which have been synchronized during the pre-deployment set up process. Then, during the deployment process, after beacon 300 verifies an inquiry signal in step 710, beacon 300 may forward the inquiry signal to other beacons in the group and present within receiving range of the inquiry signal. The forwarding may be performed by using a short-range communication method. As a result, the other beacons may emit the same response beacon signal at the same time as beacon 300, so that all of the beacons of the team will be seen as friendly by initiator 10. Alternatively, in some embodiment, if beacon 300 targeted by interrogation device 100 fails to switch on and emit a response beacon signal, other beacons in the same team as beacon 300 and within the vicinity of beacon 300 may detect the inquiry signal and emit response beacon signals at the same time.

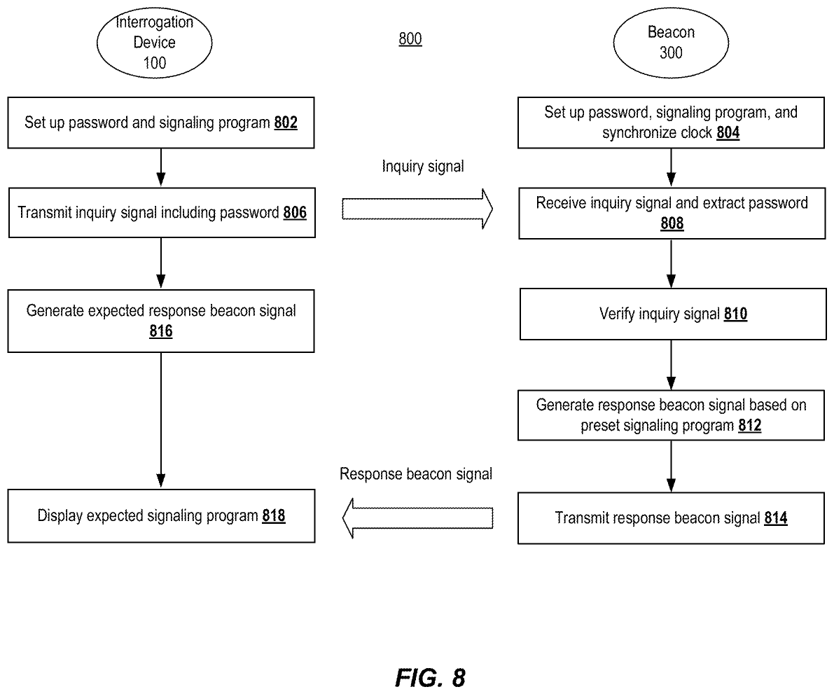

FIG. 8 schematically illustrates an IFF process 800 performed by the IFF system including interrogation device 100 and beacon 300, according to another embodiment of the present disclosure. Process 800 is similar to process 700 except that beacon 300 is configured to, upon detecting an inquiry signal, transmit a response beacon signal based on a preset signaling program.

As illustrated in FIG. 8, in step 802, interrogation device 100 sets up a password and a signaling program. In step 804, beacon 300 sets up the same password and signaling program as interrogation device 100 and is synchronized with interrogation device 100. Steps 802 and 804 are performed during the pre-deployment set-up process described with reference to FIG. 5. In step 806, interrogation device 100 transmits an inquiry signal to a target entity, here assumed to include beacon 300. The inquiry signal includes the password set up in step 802. In step 808, beacon 300 receives the inquiry signal and extracts the password included in the inquiry signal. In step 810, processor 324 of beacon 300 verifies the received inquiry signal based on the extracted password and the password set up in step 804. In step 812, processor 324 of beacon 300 generates a response beacon signal based on the signaling program preset in step 804. In step 814, beacon 300 transmits the response beacon signal. Meanwhile, in step 816, after transmitting the inquiry signal, interrogation device 100 generates an expected response beacon signal based on the signaling program which is set up in step 802. In step 818, interrogation device 100 displays the expected response beacon signal in a view finder of NVG 120 through which the response beacon signal transmitted from beacon 300 is observed. By viewing the expected response beacon signal and the response beacon signal transmitted from beacon 300 at the same time in the same viewfinder, initiator 10 may make a friend or foe decision for beacon 300.

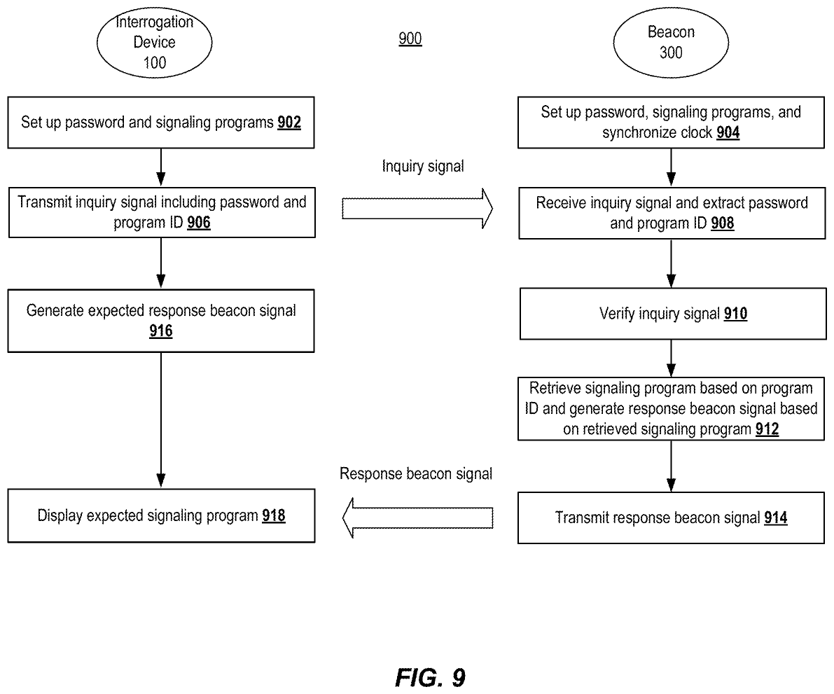

FIG. 9 schematically illustrates a process 900 performed by the IFF system including interrogation device 100 and beacon 300, according to another embodiment of the present disclosure. Process 900 is similar to process 700 except that interrogation device 100 directs beacon 300 to transmit a response beacon signal based on a selected one of a plurality of signaling programs.

As illustrated in FIG. 9, in step 902, interrogation device 100 sets up a password and a plurality of signaling programs. In step 904, beacon 300 sets up the same password and the same plurality of signaling programs as interrogation device 100, and is synchronized with interrogation device 100. For example, beacon 300 receives the password and signaling programs and stores the password and the signaling programs in memory 326. Steps 902 and 904 are performed during the pre-deployment set-up process described with reference to FIG. 5. In step 906, interrogation device 100 transmits an inquiry signal to a target entity, here assumed to include beacon 300. The inquiry signal includes the password set up in step 902 as well as an identification (hereinafter referred to as “program ID”) of a selected one of the plurality of signaling programs set up in step 902. For example, initiator 10 may select the signaling program by using control panel 150, before initiating the transmission of the inquiry signal. In step 908, beacon 300 receives the inquiry signal and extracts the password and the program ID. In step 910, processor 324 of beacon 300 verifies the received inquiry signal based on the extracted password and the password set up in step 904. In step 912, processor 324 of beacon 300 retrieves a signaling program from the plurality of signaling programs stored in memory 326 according to the program ID, and generates a response beacon signal based on the retrieved signaling program. In step 914, beacon 300 transmits the response beacon signal. Meanwhile, in step 916, after transmitting the inquiry signal, interrogation device 100 generates an expected response beacon signal based on the selected signaling program. In step 918, interrogation device 100 displays the expected response beacon signal in a view finder of NVG 120 through which the response beacon signal transmitted from beacon 300 is observed. By viewing the expected response beacon signal and the response beacon signal transmitted from beacon 300 at the same time in the same viewfinder, initiator 10 may make a friend or foe decision for beacon 300.

In some embodiments, during the pre-deployment set-up process, interrogation device 100 may be used to program a group of beacons 300. The programing may be performed in close quarters, i.e., within a room or small area, by using short-range signal. The short-range signal could be a close proximity radio signal (e.g., wifi signal or Bluetooth, or any other licensed frequency signals allocated for short range communication. The short-range signal may be tuned or coupled to a laptop by hard-wired or wireless connection. Such coupling would include use of security protocols.

In some embodiments, the IFF system may include multiple interrogation devices 100. The multiple interrogation devices 100 may communicate with each other such that if interrogation device A is programed with a password, e.g., a code of the day “1234”, then interrogation devices B, C, and D, are also programed with the same code “1234.” In addition, the multiple interrogation devices 100 may all be synchronized. This allows interrogation devices 100 in remote locations to all share the same code.

Once beacon 300 has been programed, beacon 300 can be placed in stand-by mode. In the stand-by mode, the code of the day, signaling programs, and synchronization are maintained but beacon 300 does not emit a beacon signal.

During the pre-deployment set-up process, beacon 300 that has been programed with the password and the one or more signaling programs can communicate the password and the one or more signaling programs to another beacon 300, provided that the other beacon 300 has not been programed with another code. The communication of the code between two beacons 300 is performed via a short-range signal.

In some embodiments, a beacon that has not been programed will, upon receiving a command from interrogation device 100, flash a signal pattern according to a signaling program previously stored in the beacon. This pattern, while not being synchronized with any other beacon or interrogation device 100, does however confirm that it is of the type, frequency of operation, and data protocol of interrogation device 100.

In some embodiments, during the deployment process, interrogation device 100 can be initiated to transmit a long-range inquiry signal to beacon 300 that is in stand-by mode. The long-range inquiry signal includes the programed code in interrogation device 100 (e.g., 1234). If the programed code in interrogation device 100 (e.g., 1234) matches the programed code in beacon 300, beacon 300 will switch from stand-by to active (flashing). The long-range inquiry signal is an IR signal. Over distance, wifi can be hacked more easily and security is more difficult. For this reason, in part, an IR signal is used herein as the inquiry signal. If the programed code in beacon 300 and the programed code in interrogation device 100 do not match, beacon 300 will not emit any beacon signal.

In some embodiments, during the deployment process, a beacon's battery may need to be changed. When the battery is removed from a beacon, all the previously set codes, as well as the built-in codes preset at the factory, are retained in non-volatile memory. Clock synchronization setting is lost as a result of power interruption but can be recovered by synchronizing to another beacon or an interrogation device. Synchronizing with another beacon would use a short-range signal.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An interrogation device, comprising:
an emitter configured to emit an infrared (IR) inquiry signal to a target entity to determine if the target entity is a friendly entity; and
a viewing device, configured to view IR signals, through which an IR response beacon signal from a target beacon of the target entity is viewed, the viewing device being configured to output a signal having a signal pattern of a response beacon signal expected from a beacon associated with the friendly entity, so that the target beacon is determined to be associated with the friendly entity if the response signal pattern of the target beacon matches the expected signal pattern in the viewing device.

2. The interrogation device of claim 1, wherein
the inquiry signal includes a signaling program comprising the expected signal pattern, and
the expected response beacon signal comprises the same signaling program.

3. The interrogation device of claim 1, wherein
the inquiry signal includes an identification of one of a plurality of signaling programs, the one program comprising the expected signal pattern, and
the expected response beacon signal includes the one of the plurality of signaling programs.

4. The interrogation device of claim 3, further comprising:
a central computer including a memory configured to store a plurality of signaling programs.

5. The interrogation device of claim 3, further comprising:
a control panel configured to receive a user input of a password and an identification of one of the plurality of signaling programs.

6. The interrogation device of claim 3, further comprising:
communication hardware configured to receive the plurality of signaling programs.

7. The interrogation device of claim 1, further comprising:
a clock that is synchronized with a clock of the target beacon.

8. The interrogation device of claim 7, further comprising:
a central computer that includes a processor configured to generate the expected response beacon signal according to clock times provided by the clock, such that the expected signal pattern is output at a timing that matches a timing of the response signal pattern.

9. The interrogation device of claim 1, wherein the viewing device is a night vision telescope.

10. The interrogation device of claim 1, wherein the viewing device is configured to output the expected signal pattern at a timing that matches a timing of the response signal pattern.

11. A method for an interrogation device for determining whether a target entity is a friendly entity, comprising:
transmitting, by the interrogation device, an infrared (IR) inquiry signal to the target entity; and
in response to receiving an IR response beacon signal from a target beacon of the target entity, outputting, by a viewing device on the interrogation device configured to view IR signals, through which the IR response beacon signal from the target beacon is viewed, a signal having a signal pattern of a response beacon signal expected from a beacon associated with the friendly entity, so that the target beacon is determined to be associated with the friendly entity if the response signal pattern of the target beacon matches the expected signal pattern in the viewing device.

12. The method of 11, further comprising:
in response to determining that the response beacon signal is not received, transmitting another inquiry signal.

13. The method of claim 11, wherein the inquiry signal includes a password;
the method further comprising, before transmitting the inquiry signal, receiving, from an external control device or from a user input, the password.

14. The method of claim 11, wherein the inquiry signal includes an identification of one of a plurality of signaling programs, the one signaling program comprising the expected signal pattern, and
the expected response beacon signal includes the one signaling program.

15. The method of claim 14, further comprising:
before transmitting the inquiry signal, receiving, from a user input, the identification of the one signaling program.

16. The method of claim 15, wherein the expected response beacon signal includes the selected one of the signaling programs.

17. The method of claim 16, further comprising:
before transmitting the inquiry signal, setting up the plurality of signaling programs.

18. The method of claim 11, further comprising:
generating the expected response beacon signal based on clock times provided by a clock in the interrogation device, the clock being synchronized with a clock of the target beacon such that the expected signal pattern is output at a timing that matches a timing of the response signal pattern.

19. The method of claim 11, wherein the inquiry signal includes a signaling program comprising the expected signal pattern, and the expected response beacon signal includes the same signaling program.

20. The interrogation device of claim 11, wherein the outputting the expected signal pattern comprises outputting the expected signal pattern at a timing that matches a timing of the response signal pattern.
